(19) United States
(12) Patent Application Publication
(10) Pub. No.: US 2007/0115511 A1
(43) Pub. Date: May 24, 2007

(54) Image forming device to display combination address book and displaying method thereof

(75) Inventor: Won-ho Song, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/541,705

(22) Filed: Oct. 3, 2006

(30) Foreign Application Priority Data
Nov. 9, 2005 (KR) 2005-107131

(51) Int. Cl. H04N 1/00

(52) U.S. Cl. 358/400

(57) ABSTRACT

An image forming device to display a combination address book and a displaying method thereof include a storing part to store an address book including at least one piece of transmission information on a recipient, a user interfacing part to receive a signal requesting to display the address book from a user and to display the stored address book, and a controlling part to control the transmission information corresponding to at least two transmission information fields from the stored address book, to be displayed through the user interfacing part, according to the signal requesting to display the address book.

### CROSS-REFERENCE TO RELATED APPLICATIONS

This application claims priority under 35 U.S.C. § 119(a) from Korean Patent Application No. 2005-107131, filed Nov. 9, 2005, in the Korean Intellectual Property Office, the entire contents of which are incorporated herein by reference.

### BACKGROUND OF THE INVENTION

1. Field of the Invention

The present general inventive concept relates to an image forming device to display a combination address book and a displaying method thereof. More particularly, the present general inventive concept relates to an image forming device to display a combination address book for various pieces of transmission information on a recipient and a displaying method thereof.

2. Description of the Related Art

An image forming device, such as a laser beam printer, an LPH (LED Print Head) printer, a duplicator, and a facsimile, has been used as an input output device for an office automation. A conventional image forming device has individual functions, such as printing, duplicating, scanning, and faxing, independently existing in one device, but there is a newly developed MFP (multi function printer) where various functions are integrated.

The conventional image forming device has a memory having a small space to temporarily store data provided from a host apparatus until the data is printed, but the recently developed MFP includes a storing medium, having a large memory space equivalent to an HDD (hard disk drive) of the host apparatus to store the data.

The conventional image forming device has a small displaying window just for displaying a menu under a user's operation and a simple message given to the user by the image forming device, but the recently developed MFP has a displaying window large enough to display many pieces of information at one time.

Use of such a large capacity storing medium and a large displaying window enables the image forming device to perform a part of functions which are performable at the host apparatus. For example, a function may be implemented to store an address book in the storing medium and to display the address book to the user through the large displaying window.

FIG. 1 is a view illustrating a method of displaying a combination address book of a conventional image forming device.

Referring to FIG. 1, a window 10 (10a, 10b, 10c, and 10d) is provided on the conventional image forming device. When a user wants an address book, the window 10 is displayed with icons corresponding to “fax,” “FTP (file transfer protocol),” and “email,” as illustrated in the window 10a.

The user selects the icon corresponding to a desired address book on the window 10. If the user selects “fax,” an address book including “name” and “fax number” is displayed on the window 10, as illustrated in the window job. If the user selects “FTP,” an address book including “name” and “FTP” address is displayed on the window, as illustrated in the window 10c. If the user selects “email,” an address book including “name” and “email address” is displayed on the window 10, as illustrated in the window 10d.

As abovementioned, the conventional image forming device displays the address book corresponding to a function selected by a user using 2 through 3 lines of a window, although the window 10 is a large-sized window. Accordingly, inconveniently, the user goes through several steps to confirm various pieces of address information on a recipient.

### SUMMARY OF THE INVENTION

An aspect of the present general inventive concept provides an image forming device to display a combination address book and a displaying method thereof, which provides a user with a convenient process, by storing various pieces of transmission information on a recipient in a form of table as the address book.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image forming device to display a combination address book, the image forming apparatus including a storing part to store an address book including at least one piece of transmission information on a recipient, a user interfacing part to receive a signal requesting to display the address book from a user and to display the stored address book, and a controlling part to control the transmission information corresponding to at least two transmission information fields from the stored address book, to be displayed through the user interfacing part, when the signal requesting to display the address book is received.

The transmission information may include at least one of a telephone number, a fax number, an email address, and an FTP (file transfer protocol) address.

The controlling part may control all the pieces of transmission information in the stored address book, to be displayed through the user interfacing part.

The controlling part may control at least two transmission information fields to be displayed on a screen of the user interfacing part.

The controlling part may control at least two transmission information fields to be displayed on the user interfacing part, when there is no transmission information corresponding to the two transmission information fields.

The transmission information corresponding to the transmission information field displayed on the user interfacing part under the control of the controlling part, may be applied with a scroll function.

The user interfacing part may include a key inputting part to receive the signal requesting to display the address book from the user, and a displaying part to display the stored address book. The key inputting part receives the transmission information on the recipient from the user.

The address book stored in the storing part is editable by one of an EWS (embedded web server) part and a predetermined application program.

The foregoing and/or other aspects of the present general inventive concept may also be achieved by providing a method of displaying a combination address book of an image forming device, the method including storing an address book including at least one piece of transmission information on a recipient, and displaying the transmission information corresponding to at least two pieces of transmission information fields from the stored address book, when a signal requesting to display the address book is received from the user.

The transmission information includes at least one of a telephone number, a fax number, an email address, and an FTP (file transfer protocol) address.

The displaying of the transmission information may include displaying all the pieces of transmission information of the stored address book.

The displaying of the transmission information may include displaying at least two transmission information fields on a screen.

The displaying of the transmission information may include displaying at least two transmission information fields are displayed, when there is no transmission information corresponding to at least two transmission information fields.

The foregoing and/or other aspects of the present general inventive concept may also be achieved by providing a computer readable recording medium containing computer readable codes to perform a method, the method including storing an address book including transmission information on each recipient, and displaying the transmission information corresponding to at least two pieces of transmission information fields from the stored address book according to a signal requesting to display the address book.

The foregoing and/or other aspects of the present general inventive concept may also be achieved by providing an image forming device including a storing part to store an address book including more than two transmission information fields with respect to each recipient, a user interfacing part, and a controlling part to control the user interfacing part to display the recipient name and at least two transmission information field corresponding to the recipient.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a method of displaying a combination address book of a conventional image forming device;

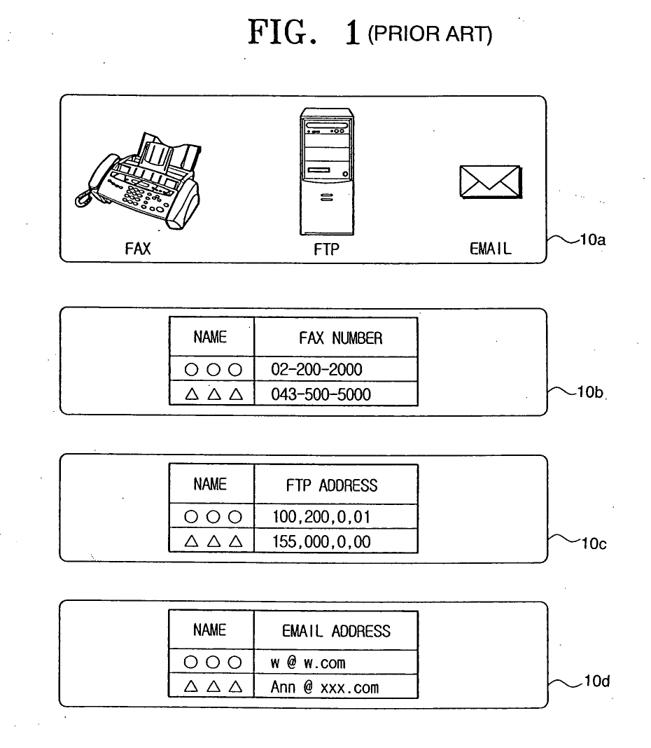

FIG. 2 is a block diagram illustrating an image forming device to display a combination address book according to an embodiment of the present general inventive concept;

FIG. 3 is a view illustrating a front panel of the image forming device of FIG. 2; and

FIG. 4 is a flowchart illustrating a method of displaying a combination address book of an image forming device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the following description, well-known functions or constructions are not described in detail since they would obscure the invention in unnecessary detail.

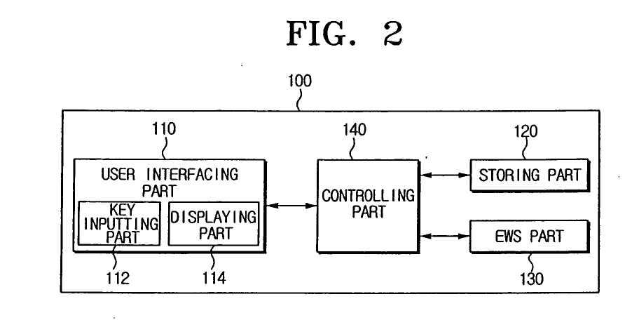

FIG. 2 is a block diagram illustrating an image forming device 100 to display a combination address book according to an embodiment of the present general inventive concept.

Referring to FIG. 2, the image forming device 100 includes a user interfacing part 110, a storing part 120, an EWS (embedded web server) part 130, and a controlling part 140.

The user interfacing part 110 provides an interface between a user and the image forming device 100, and includes a key inputting part 112 to receive a signal requesting to display an address book from the user and a displaying part 114 to display the address book.

The key inputting part 112 is disposed on a front panel of the image forming device 100 and receives at least one requesting signal under a user's operation. The key inputting part 112 has a plurality of function keys to receive a predetermined requesting signal from the user. According to the present embodiment, the key inputting part 112 may have an address book key to receive the signal requesting to display the address book.

The displaying part 114 may be disposed on the front panel of the image forming device 100 as a window. The displaying part 114 may be used as the key inputting part 112. The displaying part 114 may display the window having one or more menus under the user's operation through the key inputting part 112, and predetermined information to be provided to the user by the image forming device 100. According to the present embodiment, the window of the displaying part 114 is displayed with the address book under the control of the controlling part 140, according to a request by the user. The address book displayed on the displaying part 114 may be provided with a scroll function, if a screen of the window is not large enough to display the address book.

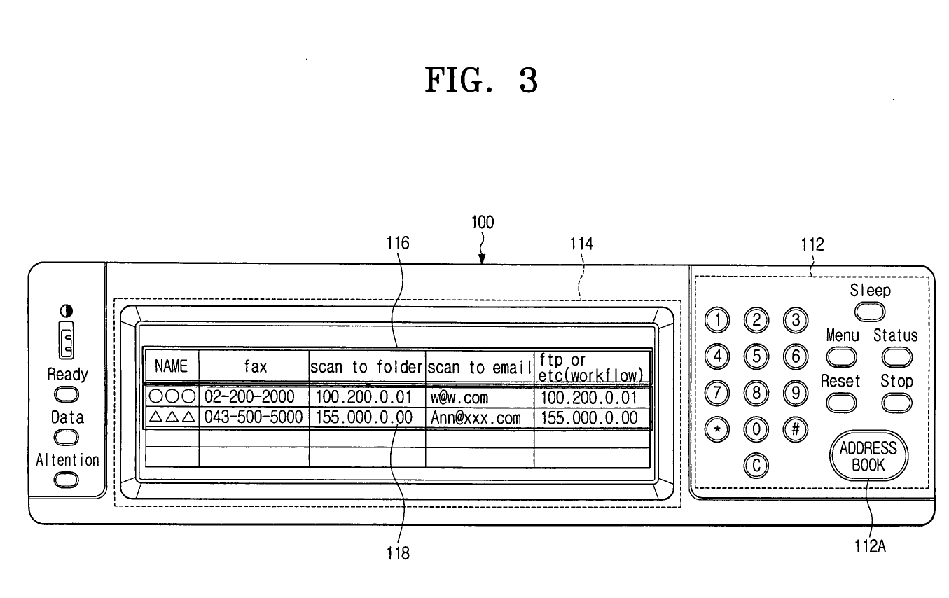

According to the present embodiment, the user interfacing part 110 includes the key inputting part 112 and the displaying part 114. When the displaying part 114 is provided with a touch screen form to perform an interface with the user, other keys may not be needed to perform the interface with the user. The user interfacing part 110, that is, the key inputting part 112 and the displaying part 114 will be described more in detail in FIG. 3 later.

The storing part 120 stores at least one piece of transmission information on each recipient received from the user. The transmission information on the recipient stored in the storing part 120 may include a telephone number, a fax number, an email address, and an FTP (file transfer protocol) address. The storing part 120 may store a transmission information field including texts of the telephone number, the fax number, the email address and the FTP address. It is possible that at least one of the telephone number, the fax number, the email address, and the FTP address is stored as the at least one piece of the transmission information on the recipient

The EWS part 130 offers a function of editing the address book stored in the storing part 120. The user may edit the transmission information on the recipient through an UI (user interface) provided from the EWS part 130, by use of editing functions such as inserting, canceling, and adding.

Usually, EWS (embedded web server) is a software developed to be used with a small-sized network device which has less performance than a web server to be used with a general computer, such as a personal computer or a work station. Accordingly, the EWS is simpler-functioned than a general web server. The EWS is efficiently used in a small-sized environment in need of one-to-one management. The EWS may be mounted in a printer to check and manage the printer and a state of a consumable item used in the printer, and to set a control panel through the Internet.

The EWS may set all the functions provided from the image forming device 100, through the UI. For example, functions settable by the EWS may include a device setting, a general setting, a tray setting, a duplicator setting, a facsimile setting, an email setting, a T.38 Internet facsimile setting, an FTP setting, an FTP server setting, an FTP client setting, an address book setting, a server list setting, a memory setting, and so on.

According to the present general inventive concept, it is exemplified to edit the address book stored in the storing part 120 through the EWS part 130, but various changes in form and details may be made therein without departing from the spirit and scope of the general inventive concept. For example, an application program to edit an address book may be used.

The controlling part 140 controls overall functions of the image forming device 100, that is, controls a signal input and output between the key inputting part 112 and the displaying part 114, and between the storing part 120 and the EWS part 130.

The controlling part 140 extracts the address book from the storing part 120, when the signal requesting to display the address book is received through the key inputting part 112 of the user interfacing part 110. The controlling part 140 controls the extracted address book to be displayed through the displaying part 114 of the user interfacing part 110.

When controlling the address book to be displayed on the displaying part 114 of the user interfacing part 110, the controlling part 140 controls all the pieces of transmission information stored in the storing part 120, to be displayed.

The controlling part 140 may control at least two transmission information fields to be displayed on the displaying part 114. The controlling part 140 controls the at least two transmission information fields to be displayed on the displaying part 114, when there is no transmission information other than the at least two transmission information fields.

When the user inputs the transmission information on the recipient through the key inputting part 112, the controlling part 140 reflects the input transmission information on the address book pre-stored in the storing part 120 by the user, thereby updating the stored address book according to the input transmission information.

When the transmission information on the recipient is changed through EWS part 130 or the application program, the controlling part 140 reflects the input transmission information on the address book pre-stored in the storing part 120, thereby updating the pre-stored address book according to the input transmission information.

FIG. 3 is a view illustrating the front panel of the image forming device of FIG. 2.

Referring to FIGS. 2 and 3, the front panel of the image forming device 100 is formed with the key inputting part 112 having the plurality of function keys, and the displaying part 114 to display the address book for the user.

The key inputting part 112 includes the plurality of function keys such as a menu key, a reset key, a number key and a stop key, and further includes a direct function key, such as an address book key 112A to input the signal requesting to display the address book.

When the user pushes the address book key 112A of the key inputting part 112, the signal requesting to display the address book is input to the controlling part 140 through the address book key 112A of the key inputting part 112. Accordingly, the controlling part 140 extracts the address book from the storing part 120 and controls the displaying part 114 to display the extracted address book.

The displaying part 114 displays the address book under the control of the controlling part 114. The displaying part 114 is displayed on a screen with a transmission information field 116 with respect to each recipient “◯◯◯” and “ΔΔΔ”, and—transmission information 118 corresponding thereto, that is, a fax number, a folder transmission address, an email address and a an FTP address.

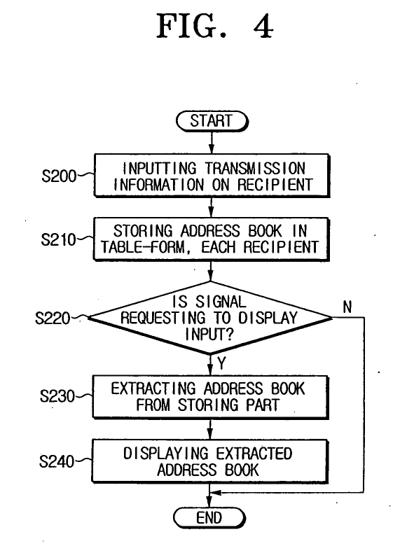

FIG. 4 is a flowchart illustrating a method of displaying a combination address book of an image forming device according to an embodiment of the present general inventive concept.

Referring to FIGS. 2 through 4, the method of displaying the combination address book of the image forming device 100 according to the embodiment of the present invention will be described hereinafter.

When registering transmission information on a recipient to an address book, a user inputs the transmission information on a recipient by operating the key inputting part 112. It is possible to change the transmission information with respect to the recipient pre-registered to the address book pre-stored to the storing part 120 (S200).

When the transmission information on the recipient is input through the key inputting part 112, the controlling part 140 controls the input transmission information to be stored in the storing part 120. A transmission information field 116 is stored together with the transmission information 118 in the storing part 120 (S210).

When conforming the address book stored in the image forming device 100, the user operates the key inputting part 112 and inputs a signal requesting to display the address book. Conveniently, the user pushes the address key 112A of the key inputting part 112 to input the signal requesting to display the address book (S220).

In the operation of S220, when the signal requesting to display the address book is input from the user, the controlling part 140 extracts the address book from the storing part 120 (S230), and controls the displaying part 114 to display the extracted address book. As illustrated in FIG. 3, the displaying part 114 displays the address book including the transmission information field 116 and the transmission information 118 corresponding thereto (S240).

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

With the abovementioned process, the user is provided with various pieces of transmission information such as a recipient's telephone number, a fax number, an email address, and the FTP address from a screen, without being required to go through unnecessary steps.

As abovementioned, according to an embodiment of the present general inventive concept, an image forming device to display a combination address book and a displaying method thereof, enables a user to receive pre-registered various pieces of transmission information on a recipient through the image forming device, thereby removing the need to go through several and/or unnecessary steps for searching for desired transmission information in use of the address book, for example in transmission of data, and providing a using convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device to display a combination address book, comprising:
a storing part to store an address book including transmission information on a recipient;
a user interfacing part to receive a signal requesting to display the address book from a user and to display the stored address book; and
a controlling part to control the transmission information corresponding to at least two transmission information fields from the stored address book, to be displayed through the user interfacing part, according to the signal requesting to display the address book.

2. The image forming device of claim 1, wherein the transmission information comprises at least one of a telephone number, a fax number, an email address, and an FTP (file transfer protocol) address.

3. The image forming device of claim 1, wherein the controlling part controls all the pieces of transmission information in the stored address book to be displayed through the user interfacing part.

4. The image forming device of claim 1, wherein the controlling part controls the at least two transmission information fields to be displayed on a screen of the user interfacing part.

5. The image forming device of claim 1, wherein the controlling part controls the user interfacing part to display the at least two transmission information fields when there is no transmission information other than at least two transmission information fields.

6. The image forming device of claim 1, wherein the controlling part controls the user interfacing part to display the transmission information corresponding to the transmission information field together with a scroll function.

7. The image forming device of claim 1, wherein the user interfacing part comprises:
a key inputting part to receive the signal requesting to display the address book from the user; and
a displaying part to display the stored address book.

8. The image forming device of claim 7, wherein the key inputting part receives the transmission information on the recipient from the user.

9. The image forming device of claim 1, wherein the address book storied in the storing part is editable by one of an EWS (embedded web server) part and a predetermined application program.

10. A method of displaying a combination address book of an image forming device, comprising:
storing an address book including transmission information on a recipient; and
displaying the transmission information corresponding to at least two pieces of transmission information fields from the stored address book, according to a signal requesting to display the address book received from a user.

11. The method of claim 10, wherein each of the at lease two pieces of the transmission information fields comprises at least one of a telephone number, a fax number, an email address, and an FTP (file transfer protocol) address.

12. The method of claim 10, wherein the displaying of the transmission information comprises displaying all the pieces of transmission information of the stored address book.

13. The method of claim 10, wherein the displaying of the transmission information comprises displaying at least two transmission information fields on screen.

14. The method of claim 10, wherein the displaying of the transmission information comprises displaying at least two transmission information fields, when there is no transmission information other than at least two transmission information fields.

15. The method of claim 10, further comprising:
editing to stored address book through a user interface
wherein the at lease two pieces of the transmission information fields are displayed on the user interface.

16. The method of claim 10, further comprising:
providing a key corresponding to the signal; and
receiving the signal according to an input of the key

17. A computer readable recording medium containing computer readable codes to perform a method, the method comprising:
storing an address book including transmission information on each recipient; and
displaying the transmission information corresponding to at least two pieces of transmission information fields from the stored address book according to a signal requesting to display the address book.

18. An image forming device, comprising;
a storing part to store an address book including more than two transmission information fields with respect to each recipient;
a user interfacing part; and
a controlling part to control the user interfacing part to display the recipient name and at least two transmission information fields corresponding to the recipient.

19. The image forming apparatus of claim 18, where in the user interfacing part comprises a display part and a key inputting part to provide a one-touch key corresponding to the signal, and the controller controls the display part to display the recipient name and to at least two transmission information fields according to the one-touch key.

20. The image forming apparatus of claim 19, where in the key inputting part of the user interfacing part comprises a plurality of keys and to one-touch key, and the controller controls the display part to display the recipient name and the at least two transmission information fields according to one-touch key without manipulating the plurality of keys.

21. The image forming apparatus of claim 18, wherein:
the recipient comprises a first recipient and a second recipient; and
the user interfacing part comprises a first line to display the first recipient and the at least two transmission information fields corresponding to the first recipient, and a second line to display the second recipient and the at least two transmission information fields corresponding to the second recipient.

22. The image forming apparatus of claim 18, wherein:
the recipient comprises one or more recipients, and the user interfacing part comprises one or more lines; and
each of the one or more recipients and the at least two transmission information fields corresponding to the each of the one or more recipients are displayed on corresponding ones of the one or more lines.
